(19) United States
(12) Patent Application Publication
(10) Pub. No.: US 2014/0103685 A1
(43) Pub. Date: Apr. 17, 2014

(54) Lightweight Cross-Car Beam and Method of Construction

(71) Applicant: Ayyakannu Mani, Rochester Hills, MI (US)

(72) Inventor: Ayyakannu Mani, Rochester Hills, MI (US)

(21) Appl. No.: 14/049,630

(22) Filed: Oct. 9, 2013

Related U.S. Application Data
(63) Continuation-in-part of application No. 12/932,338, filed on Feb. 23, 2011, now abandoned.

(51) Int. Cl. B62D 25/14

(52) U.S. Cl. CPC B62D 25/145
USPC 296/193.02; 29/897.2

(57) ABSTRACT

A cross car beam is constructed as a tubular member including a series of bracing plates internally bracing a series of tubular member segments to markedly increase its strength and stiffness so that a much lighter cross beam is obtained.

### CROSS REFERENCE TO RELATED APPLICATIONS

This application is a continuation in part of U.S. Ser. No. 12/932,338 filed on Feb. 23, 2011 which claims the benefit of U.S. provisional application No. 61/338,963 filed on Feb. 25, 2010.

### BACKGROUND OF THE INVENTION

There are considerable on-going efforts to reduce the weight of automobiles in order to improve fuel economy and performance, particularly acute need with the need to comply with strong government standards. This particularly includes the various structural elements of the automobile body.

These efforts include the substitution of lighter materials such as aluminum and magnesium for conventionally used steel.

Another always crucial consideration is cost (both in tooling and production), particularly in times of industry financial stress.

A key major structural component is the cross car beam which is the backbone of the instrument panel in an automobile. This beam extends laterally between the “A” pillars to provide support for various diverse components located at the front end of the passenger compartment, i.e., the steering column, passenger airbag, entertainment/information modules, electronic accessories, and heating and cooling ducting components and glove box. Typically various component mounting brackets or supports are provided for the components to be mounted to the cross car beam.

New federal government fuel economy regulations (54 mpg Corporate Average Fuel economy (CAFÉ) by 2025) require significant weight reductions in automotive structures along with other measures such as high efficiency engines etc. as the current CAFÉ level is around 27 mpg.

Such beams have been formed by a series of structures for each mounting section connected together to form a structural member.

Prior practice has included a cross car beam comprising a one-piece hollow tubular steel member or a two piece hollow, tubular steel member, the two pieces joined together end to end in an effort to reduce the weight of the beam.

The cross car beam needs to meet multiple requirements to function well: it needs to be stiff enough to support the steering column and several attachments to it such as center stack, HVAC assemblies, passenger airbag module and glove box structures, and strong enough to resist side impact and front crash loads. There is a necessity for substantial stiffness in supporting the steering column since any steering wheel shake adversely affects the perception of the driver as to the quality of construction of an automobile.

Oftentimes, the required stiffness and strength of such tubular beams are achieved by increasing the diameter, increasing the wall thickness, adding longitudinal extending internal ribs and/or adding external reinforcements. The first three of these features extend the entire length of the beam, even if the beam requires only a localized stiffening or strengthening and therefore are an inefficient use of material.

The fourth measure, adding reinforcements at several locations, is spread over a large curved surface area of the beam and they also represent a relatively inefficient use of material.

Therefore, these cross car beams are heavier than necessary.

It is an object of the present invention to provide a cross car beam member which is configured so as to achieve more efficient use of material so as to weigh significantly less than prior art cross car beams, and thus contribute to reducing the weight of the vehicle and thereby contributing to improved fuel economy of the vehicle.

### SUMMARY OF THE INVENTION

The above object and other objects which will be understood by those skilled in the art are achieved by a cross car beam of substantially reduced weight while still providing the strength and rigidity necessary. A cross car beam according to the invention is comprised of a tubular member preferably made up of a series of segments, attached together end to end to form a continuous member extending completely across the passenger compartment. Each segment is braced internally against collapse by a transverse disc plate which may be located at one end of each segment.

The presence of the relatively small disc plates very efficiently strengthens and stiffens the tubular member since the disc plates add only slightly to the weight of the beam, as the wall thickness of the tubular member may be thinned substantially. Thus, total weight of material required is reduced, making the total weight of the cross car beam substantially less.

One or more of the discs can advantageously be located along the beam at mounting points for the various brackets, etc. along the cross care beam.

In addition localized thickening of the wall thickness can be used at the ends of the cross car beams where the beam is attached or adjacent the points of attachment of brackets, etc. and where the steering gear is mounted where greater stiffness and strength is required.

Also, one or more of the disc plates could be larger than the tubular section to allow mating of misaligned or angled tubular segments of the cross car beam and to facilitate welding of the segments together.

The tubular member can be straight or can be formed with bends as necessary. In this case, the bracing plates are advantageously located at the bends.

### DESCRIPTION OF THE DRAWINGS

FIG. 1 is a pictorial view of a cross car beam according to the present invention.

FIG. 1A is an exploded pictorial view of the cross car beam shown in FIG. 1

FIG. 1B is an enlarged fragmentary pictorial view of one end of the cross car beam shown in FIGS. 1 and 1A.

FIG. 2 is a pictorial view of an alternative embodiment of a cross car beam according to the invention.

FIG. 2A is an enlarged pictorial sectional fragmentary view of another embodiment of a cross car beam according to the present invention.

FIG. 3 is a pictorial view of a cross car beam according to the invention with attached support bracketry and steering wheel and column.

FIG. 4 is a reverse pictorial view of a cross car beam according to the invention with attached bracketry and diagrams of side impact loading.

FIG. 5A is a plot of a side loading to failure of a cross car beam with and without bracing disc plates.

FIG. 5B is a plate of the side loading of a cross car beam with ribs and with and without disc plates.

FIG. 5C is a plot of a cross car beam according to the invention and a conventional steel cross car beam loaded to failure from the side and indicating the load at which failure occurs.

FIG. 6 is a tabulation of beam weights and stiffnesses for three different cross car beam constructions.

FIG. 7 is a tabulation of force levels in side loading to failure of a tubular cross car beam with and without various strengthening features on cross car beams, together with the weights of such beams.

FIG. 8 is a plan view of a curved cross car beam according to the invention.

FIG. 8A is an exploded plan view of the curved cross car beam shown in FIG. 8.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

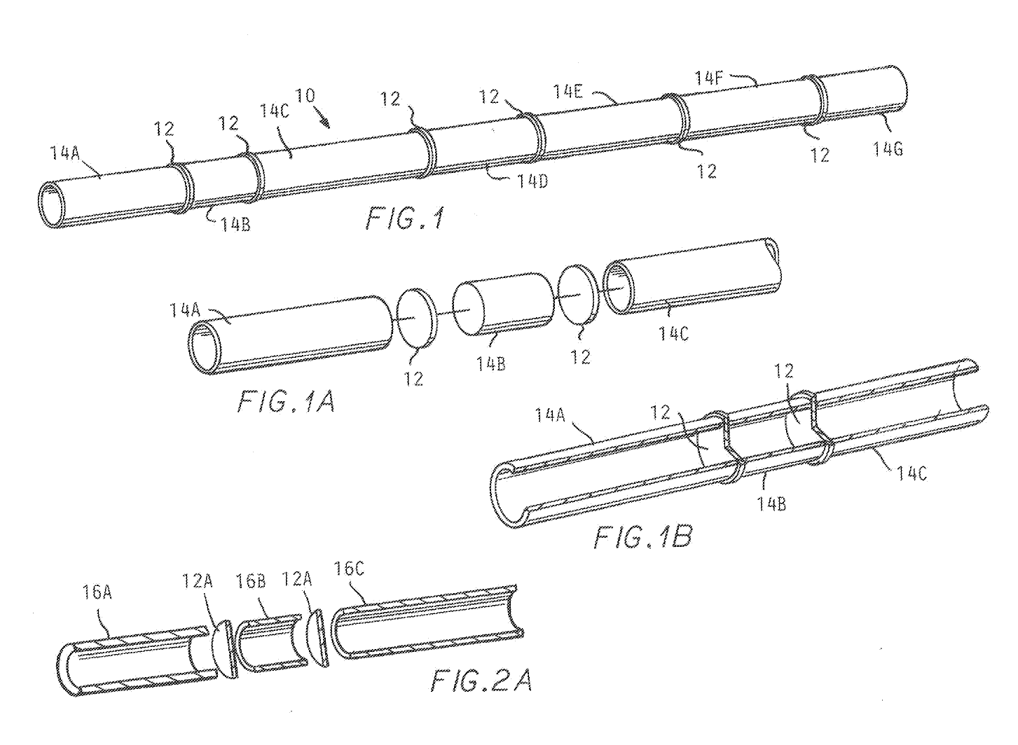

Referring to the Drawings, and in particular FIGS. 1A and 1B in which a cross car beam and portions thereof according to the invention are shown.

The cross car beam 10 is formed from a straight hollow tube preferably of aluminum, cut into segments 14A-14G. An aluminum disc plate 12 is fixed to one end of each segment 14A-14G.

According to the present invention, the thickness of the tube 10 is minimized by being braced internally against collapse with the disc plates 12 extending across the inside diameter and secured thereto as by welding. The disc bracing plates 12 may be made of a slightly larger diameter than the diameter of the tube segments 14A-14G to create a ridge for ease in welding the segments together as well as in welding the disc plates to the associated tube segment 14A-14G.

Cross car beams must have sufficient strength to withstand axial loadings by side impacts as well as to support various components as by brackets attached tending to twist and bend the beam. The beam must not deflect excessively to maintain a solid feel, particularly of the steering wheel, which has a tendency to vibrate while the car is in motion if the cross car beam deflects in torsion to an excessive degree.

At the same time, the beam must be as light as possible in the interests of maximizing the fuel efficiency of the vehicle.

It has been discovered that a pronounced improvement in stiffness and strength of such a cross car beam can be achieved by the affixation of the disc plates 12 to each segment which brace the tubing against collapse when loaded axially or in bending.

By analyzing the given beam configurations of various wall thicknesses with a number of internal discs, a very light weight cross car beam can be produced by reducing the wall thickness to a minimum while still achieving the necessary levels of stiffness and strength of the cross car beam.

Furthermore, it has been found that the addition of such internal bracing plates creates markedly improved stiffness and strength of the beam which substantially surpasses prior art reinforcements such as ribs or localized external reinforcements, an increased outside diameter or wall thickness.

In addition, the weight penalty of such internal bracing is much less than that incurred by simply increasing the wall thickness of the tube to the extent necessary to produce the required stiffness and strength.

Accordingly, a significantly lighter cross car beam can be produced than by conventional design approaches to reinforcement or strengthening.

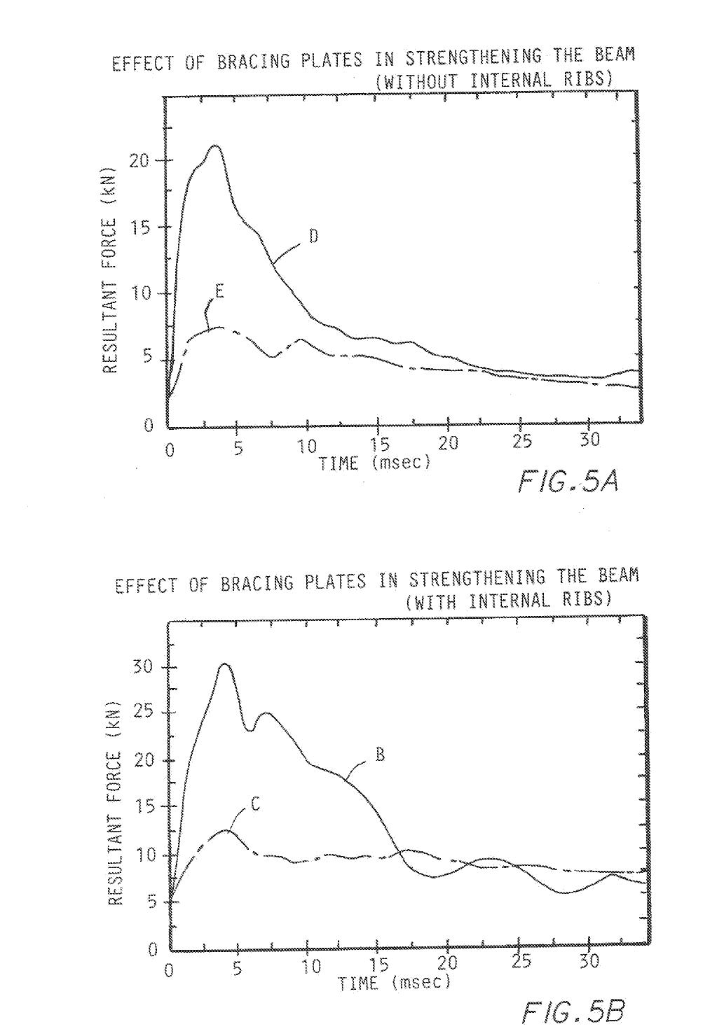

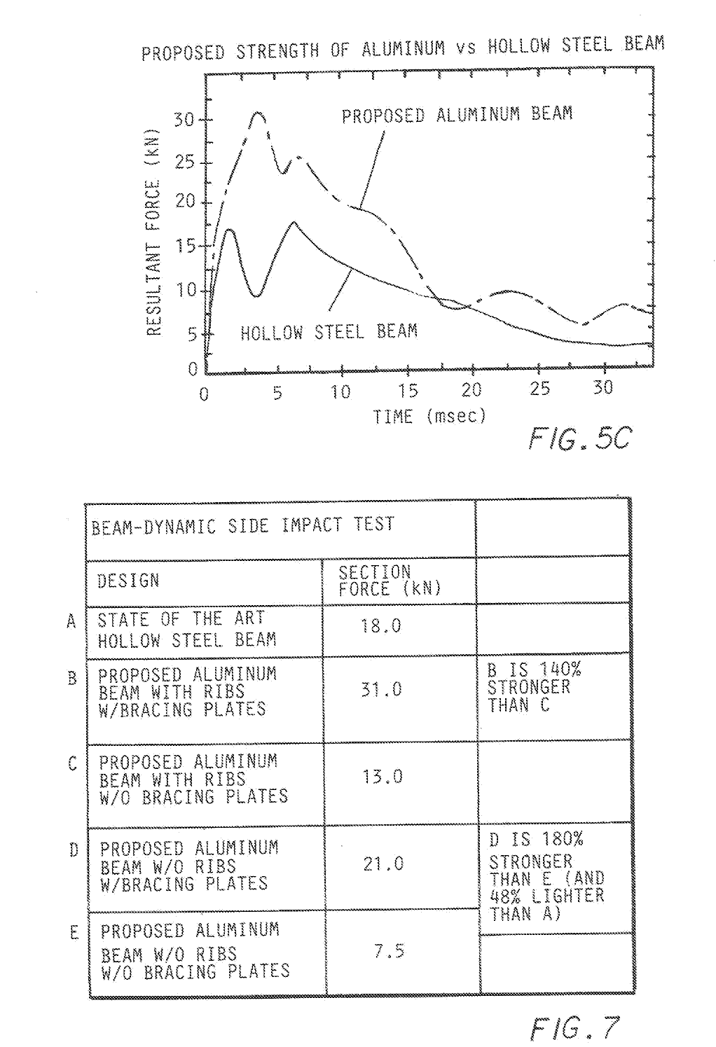

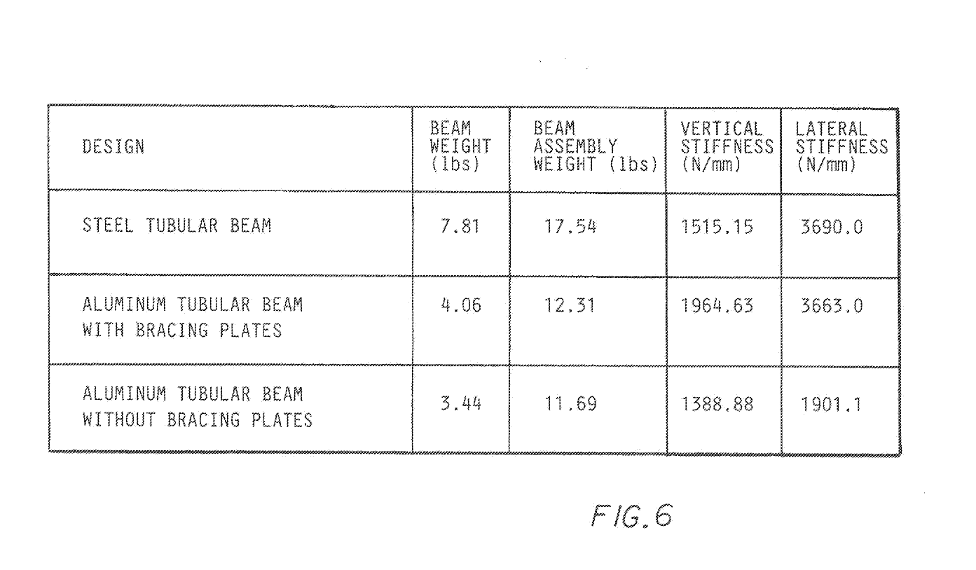

The effect of internal bracing disc plates (or square plates for square tubes, etc.) can be appreciated by reference to the internal bracing plates of FIGS. 5A, 5B and 5C and the charts of FIGS. 6 and 7.

As shown in FIG. 5A, the load is calculated to buckle a cross car beam is much higher when bracing plates are included (plot D) than when not included (plot E). The letters correspond to the beam design listings of the chart of FIG. 7.

The plot of FIG. 5B shows that in contrast, there is only a minor effect on strength and stiffness in adding ribs (Plots B and C).

FIG. 5C depicts a plot of the calculated load applied to a steel beam compared to an internally reinforced aluminum beam.

In FIG. 6, the marked increased strength of an aluminum tubular beam with internal bracing plates and the marked reduction in weight over a tubular steel cross car beam can be seen, while providing equal or better stiffness and strength.

In FIG. 7, that tabulation shows the marked increase in strength to resist buckling from side impacts of a cross car beam with the addition of internal bracing plates compared to conventional reinforcement or strengthening using longitudinal ribs.

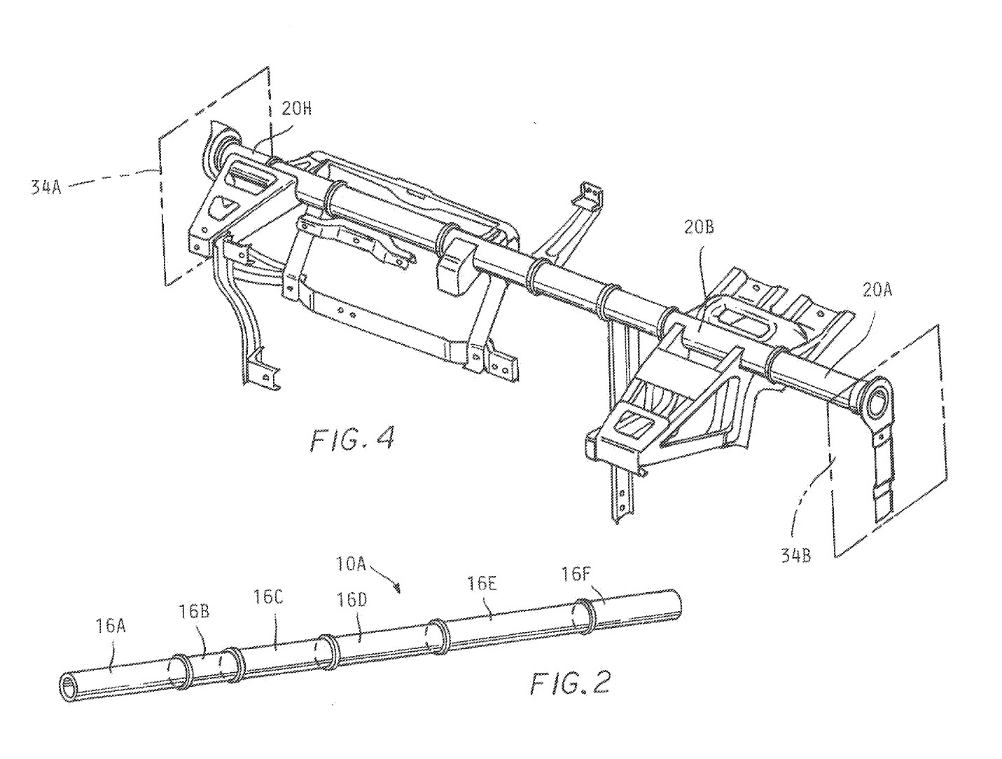

FIGS. 2 and 2A show a tubular cross car beam 10A composed of separate segments of tubing 16A-16F with internal bracing plates 12A having different wall thicknesses in end segments 16A, 16F of the beam 10A compared to other segments 16B, 16C, 16D and 16E. Also other segments than the end segments can be made thicker (or thinner).

Thus a more heavily loaded segment can be supported in a localized segment of the beam to achieve more efficient use of material and an overall lighter beam correspond to the loading of a particular segment

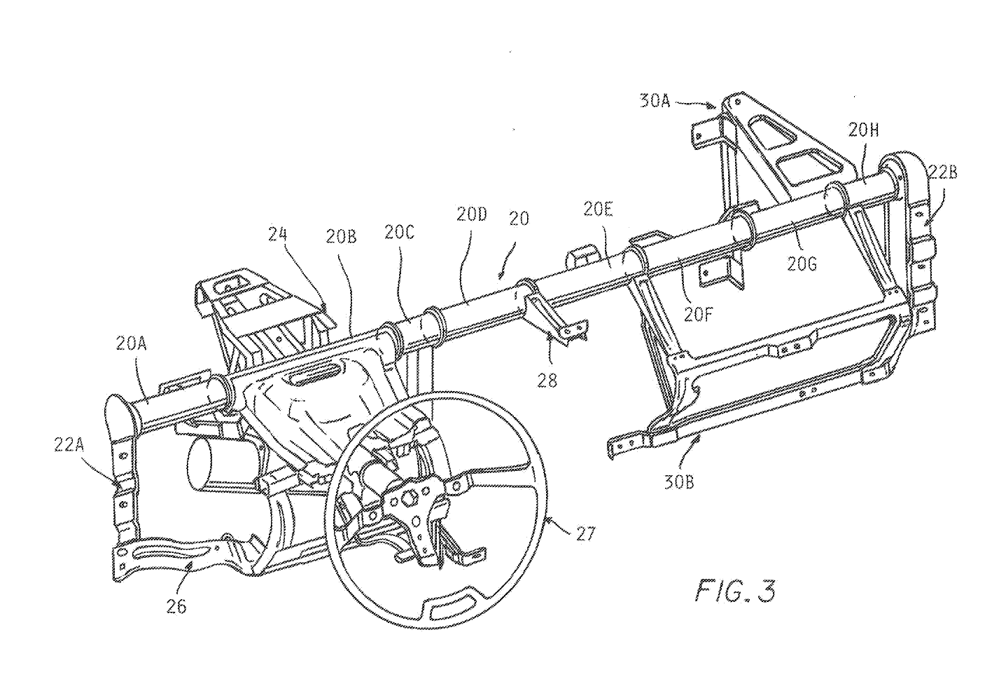

FIGS. 3 and 4 show such a cross car beam 20 with bracketry provided to support various parts. The cross car beam 20 is supported by end brackets 22A, 22B secured to the vehicle frame (not shown) in the well known manner.

A steering column support 24 is secured to a sturdier left segment 20A of the cross car beam 20 next to end bracket 22A with supplemental bracket 26 adding additional support for the steering wheel and column 26.

Center stack bracket 28 is attached at the center of the right segment 20B of the cross car beam 20.

Glove box-air bag support brackets 30A, 30B support the glove box and passenger side air bag canister (not shown).

FIG. 4 depicts diagrammatically the end walls 34A, 34B loading the cross car beam 20 in a side impact collision.

For this reason, increased localized wall thickness segments at the ends 20A, 20G may be employed to resist the heaver stress at the ends of the cross car beam 20.

Stiffness of the cross car beam was computed using the NASTRAN software. Originally developed by NASA, it is an abbreviation of NASA STRUCTURAL ANALYSIS. It is widely used globally in many industries such as automotive, aerospace, etc. to develop products. A finite element model of the complete geometry is first created. Loads, boundary conditions, and material properties are then defined. Subsequently the model is analyzed on powerful computer to obtain the deflections, stresses etc. stiffness is computed using the definition Stiffness=Loaded/Deflection, under linear assumptions for small deflections. Strength of the cross car beam was computed using the LS-SYNA software. Originally developed by the Livermore National Lab for impact analysis of armors, projectiles and bullets, it is widely used globally in many industries such as automotive, aerospace etc. to develop products undergoing impact/crash/collapse. Here also a finite element model of the complete geometry is first created (this is typically more detailed/refined than that for stiffness analysis). Loads, boundary conditions, and material properties are then defined. Contacts between various parts are also defined. Subsequently the model is analyzed on powerful computers to obtain the deflections, stresses, strains, etc. Strength is defined as the maximum load a structure can take before failure.

The tubular member can be straight or can be formed with bends as necessary. In this case, the bracing plates are advantageously located at the bends.

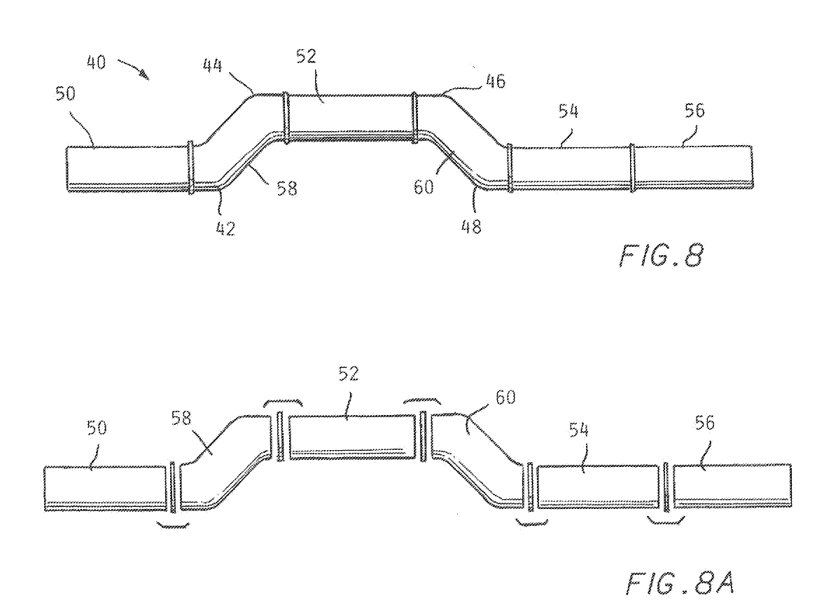

FIGS. 8 and 8A show a cross car beam 40 with bends 42, 44, 46, 48 to accommodate the supported components.

In this case, straight tubular segments 50, 52, 54, 56 are provided combined with tubular segments 58, 60 formed with the bends 42-48.

In this case, bracing plates 62 are affixed to join the segments with ends 58, 60 to the straight segments 50-56.

1. A method of making a light weight cross car beam comprising:
forming a series of tubular segments of a combined length equal to the total length of the cross car beam; attaching a bracing plate to one end of each of said tubular segments extending completely across each said tubular segment to provide, to form on an internal bracing of each segment, resisting collapse of each of said tubular segments; and
attaching said segments together end to end with an abutting junction between said joined tubular segments with a bracing plate at said junction.

2. The method according to claim 1 further including configuring tubular segments at each end of said cross car beam to have a heavier wall thickness of tubular segments at the end than the remaining tubular segments.

3. The method according to claim 1 wherein brackets are attached to said cross car beam spaced along the length thereof for supporting components of a automobile thereon, and further including locating a bracing plate at the location of one or more of said brackets.

4. The method according to claim 1 wherein said tubular segments are round in cross section and further including abutting disc plates against an end of one of said tubular segments.

5. The method according to claim 4 including configuring said disc plates to be slightly larger in diameter than the diameter of said tubular segments and further including welding said disc plates to an end of adjacent tubular segments.

6. A cross car beam adapted to be attached to an automobile body extending completely across the forward end of a passenger compartment and mounting for a steering column, center consoles and a glove box and a passenger side air bag, comprising a series of tubular segments of a combined length extending completely across said passenger compartment; each of said tubular segments having a bracing plate affixed thereto occupying the interior of at least one end of each tubular segment, said tubular segments attached to one another in an end to end series.

7. The cross car beam according to claim 6 wherein a tubular segment at each end of said cross car beam has a tubular wall thickness thicker than the remaining tubular segments of said cross car beam.

8. The cross car beam according to claim 6 wherein a bracing plate is located at points of attachments of said mountings to said cross car beam.

9. The cross car beam of claim 6 wherein said tubular segments are round in section and said bracing plates comprise discs.

10. The cross car beam according to claim 6 wherein said tubular segments are connected together to form a straight cross car beam.

11. The cross car beam according to claim 6 wherein said bracing plates are slightly larger than said tube segments cross sections and are welded to connect said bracing plates thereto as well as to the next adjacent tube segment.

12. The cross car beam according to claim 6 wherein some of said tube segments have bends and others are straight and bracing plates are located at junctions between straight and tube segments with bends.
